(19) United States
(12) Patent Application Publication
(10) Pub. No.: US 2017/0291572 A1
(43) Pub. Date: Oct. 12, 2017

(54) BELT TENSIONER AND VEHICLE WITH A BELT TENSIONER

(71) Applicant: DAIMLER AG, Stuttgart (DE)

(72) Inventors: Christian BURCZYK, Stuttgart (DE); Till HEINRICH, Stuttgart (DE)

(21) Appl. No.: 15/094,058

(22) Filed: Apr. 8, 2016

(51) Int. Cl. B60R 22/46

(52) U.S. Cl. CPC B60R 22/4619; B60R 22/4628; B60R 2022/1806

(57) ABSTRACT

A belt tensioner tightens a belt strap of a vehicle seat belt whose belt buckle tongue, which is arranged movably on the belt strap, is inserted into a belt buckle. The belt buckle is attached to a retaining cable having a cable guide formed in such a way that one length of a guide path of the retaining cable can be extended in the cable guide to tighten the belt strap.

### BACKGROUND AND SUMMARY OF THE INVENTION

Exemplary embodiments of the invention relate to a belt tensioner for a seat belt of a vehicle for tightening a belt strap whose belt buckle tongue, which is arranged movably on the belt strap, is inserted into a belt buckle. Exemplary embodiment of the invention also relate to a vehicle having such a belt tensioner.

A seat belt for a vehicle is generally known. The seat belt comprises a belt tensioner, which automatically tightens a belt strap of the seat belt when an imminent collision of the vehicle is detected or when a collision is detected. Due to tightening, the belt strap lies tightened flat against the body of a passenger wearing the belt strap such that the passenger is restrained before or relatively early in the collision process.

Exemplary embodiments the invention are directed to an improved belt tensioner compared to prior art for a seat belt of a vehicle and a vehicle having such a belt tensioner.

A belt tensioner for a seat belt of a vehicle serves to tighten a belt strap whose belt buckle tongue, which is arranged movably on the belt strap, is inserted into a belt buckle. According to the invention, a cable guide of a retaining cable of the belt buckle is provided, which is formed in such a way that one length of a guide path of the retaining cable can be extended in the cable guide to tighten the belt strap.

The belt tensioner formed in such a way allows the combination of a comfort function, i.e. a feed function for the belt buckle, and a tightening of the belt strap in the event of collision. In addition, both a pyrotechnical and a reversible belt buckle movement can be created using the belt tensioner. The reversible belt buckle movement serves to move the belt buckle from an operating position into a feed position and back, wherein belt slack is reduced during this movement back into the operating position. The pyrotechnical belt buckle movement, i.e. the irreversible belt buckle movement, is provided for tightening the belt strap in the event of a collision.

In addition, the belt buckle is attached to a vehicle structure regardless of a time point and/or a travel position, wherein the cable guide does not bear a load caused by the collision due to a tensile force acting on the belt buckle.

### BRIEF DESCRIPTION OF THE DRAWING FIGURES

Exemplary embodiments of the invention are illustrated in greater detail below by means of drawings.

Here are shown:

FIG. 1 schematically, a belt buckle having a cable guide in a first embodiment in a starting position,

FIG. 2 schematically, the belt buckle having the cable guide in the first embodiment in an active position and

FIG. 3 schematically, the belt buckle having the cable guide in a second embodiment in the starting position.

Parts that correspond to one another are provided with the same reference numerals in all figures.

### DETAILED DESCRIPTION

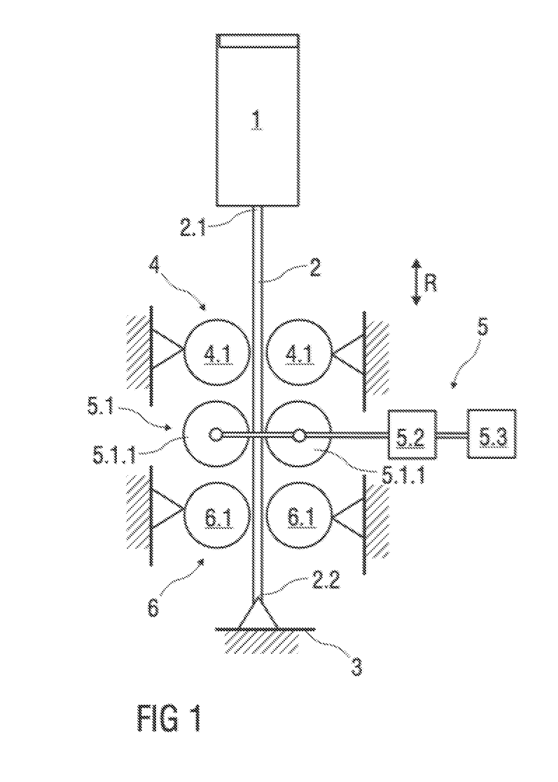

FIG. 1 shows a belt buckle 1 having a cable guide in a first embodiment, wherein a belt strap, which is not shown in more detail, can be tightened by the cable guide.

For this purpose, a belt buckle tongue, which is arranged movably on the belt strap, is inserted into the belt buckle 1. The belt buckle 1 is arranged on one end 2.1 of a retaining cable 2, wherein an opposite end 2.2 of the retaining cable 2 is connected to a vehicle structure 3 in a load-bearing manner.

Both the belt strap and the belt buckle 1 are components of a seat belt arranged in a vehicle, wherein the belt strap can be tightened by the cable guide to reduce the risk of injury for a passenger wearing the belt strap.

In particular, the belt strap can be tightened by the cable guide to reduce the risk of injury when an imminent collision of the vehicle is detected or when a collision of the vehicle is detected.

In addition, the cable guide having the belt buckle 1 represents a belt buckle feeder, wherein the belt buckle 1 can be moved between a feed position, i.e. a function allowing easy attachment or detachment of the belt to the belt buckle, and an operating position.

The cable guide is thereby formed in such a way that one length of a guide path of the retaining cable 2 can be extended in the cable guide to tighten the belt strap, i.e. to reduce belt slack.

In particular, the cable guide in FIG. 1 is depicted in a starting position, wherein the retaining cable 2 according to the present exemplary embodiment extends in a straight line in a vertical direction R. The starting position is thereby understood to be the feed position of the belt buckle 1.

The cable guide comprises the retaining cable 2 having the belt buckle 1, an upper pair of guide rollers 4, a deflector 5 having a movable pair of rollers 5.1, a brake 5.2, and a drive 5.3, as well as a lower pair of guide rollers 6.

Alternatively or additionally, the cable guide can also comprise other elements to deflect the retaining cable 2.

In the first embodiment of the cable guide, the upper pair of guide rollers 4, the movable pair of rollers 5.1 and the lower pair of rollers 6 have the same diameter. The upper pair of guide rollers 4 thereby forms an upper slotted guide and the lower pair of guide rollers 6 thereby forms a lower slotted guide, wherein the pair of rollers 5.1 arranged between these forms a movable slotted link. In particular, the pair of rollers 5.1 is arranged so as to be able to be moved laterally between the pairs of guide rollers 4, 6.

The guide rollers 4.1 of the upper pair of guide rollers 4, guide rollers 6.1 of the lower pair of guide rollers 6 and the rollers 5.1.1 of the movable pair of rollers 5.1 are thereby arranged next to one another respectively, wherein the guide rollers 4.1, 6.1 and the rollers 5.1.1 in the present exemplary embodiment according to FIG. 1 are aligned in the same direction.

The retaining cable 2 is arranged relative to the cable guide in such a way that the retaining cable 2 runs between the guide rollers 4.1, 6.1 of the pairs of guide rollers 4, 6 and between the rollers 5.1.1 of the movable pair of rollers 5.1.

In addition, the movable pair of rollers 5.1 is coupled to both the brake 5.2 and the drive 5.3. The drive 5.3 serves to move the pair of rollers 5.1 and is, for example, an electric motor. The brake 5.2 can be, for example, a wedge brake and/or a latching tooth arrangement and is provided for fixing the pair of rollers 5.1 in a specific position. Alternatively or additionally, a braking effect takes place by means of classic friction pairing via contact pressure.

To activate the cable guide, in particular the deflector 5, a passenger puts on the belt strap allocated to the belt buckle 1 and inserts the belt buckle tongue into the belt buckle 1. Here, the belt buckle 1 is in the starting position, so the feed position.

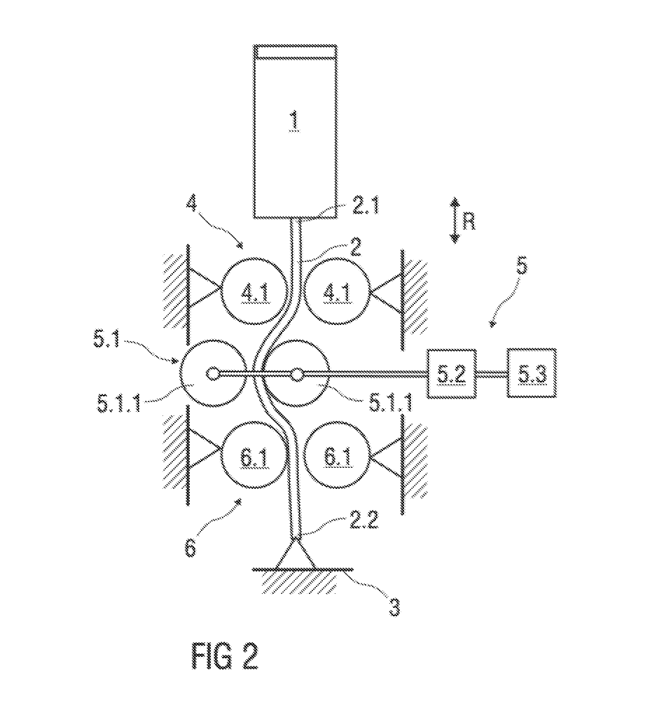

The drive 5.3 can be controlled to tighten the belt strap, in particular to ensure that the belt strap lies flat against the passengers body. The pair of rollers 5.1 of the deflector 5 according to the present exemplary embodiment according to FIG. 2 can thus be moved in a horizontal direction and can be fixed in this position by means of the brake 5.2. A region of the retaining cable 2 is deflected from a straight guide path by the deflector in order to tighten the belt strap. The belt buckle 1 and the cable guide are depicted in FIG. 2 in an active position, i.e. in the operating position.

The brake 5.2, which forms a locking device, prevents a movement of the belt buckle 1 in the direction of the starting position, i.e. the feed position, to the greatest extent possible due to a tensile force acting in a restraint situation. Alternatively or additionally, a separate locking device can be provided.

Due to the movement of the pair of rollers 5.1, the retaining cable 2 is curved, whereby the guide path of the retaining cable 2 is extended and the belt buckle 1 approaches a predetermined path of the vehicle structure 3. A distance between the belt buckle 1 and the vehicle structure 3 is reduced, whereby the belt strap is tightened and belt slack is thus reduced.

A pyrotechnical belt tensioner (not shown) is arranged in one possible embodiment in a pitch line in front of or behind the drive 5.3, wherein the pyrotechnical belt tensioner can alternatively or additionally be arranged in the region of the vehicle structure 3, on the end 2.2 of the retaining cable 2, which is opposite the belt buckle 1.

In a further embodiment, the guide path of the retaining cable 2 can be extended in stages. The guide path can thus be extended in one stage as a comfort function and in a further stage can be extended by a further section as a safety function, in particular before the occurrence of a collision of the vehicle. The belt strap can thus be tightened in at least two stages.

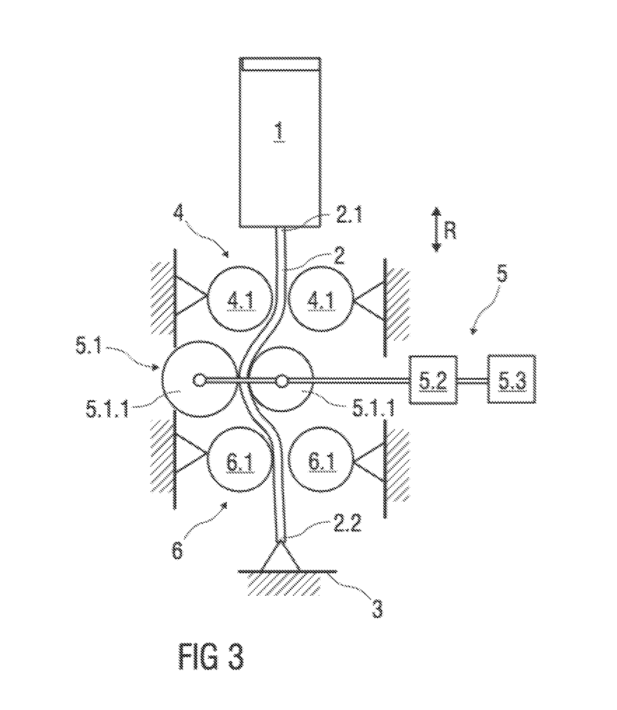

FIG. 3 shows a second embodiment of the cable guide for the extension of the guide path of the retaining cable 2, wherein the cable guide is depicted in the operating position.

In the second embodiment, the two rollers 5.1.1 of the pair of rollers 5.1 have different diameters such that one of the rollers 5.1 is larger than the other one.

Due to the different sizes of the rollers 5.1.1 and, as a consequence, the different sized contact surfaces of the retaining cable 2 on the rollers 5.1.1, the belt buckle 1 can be moved at different speeds using the same speed of the drive 5.3. The larger at least one of the two rollers 5.1.1 is relative to the other roller the faster the belt buckle 1 can be moved during a constant speed of the drive 5.3, in particular locally.

As described above, the pair of rollers 5.1 can be moved laterally, wherein a movement in one direction takes place in a reversible manner using the drive 5.3 in the form of the electric motor and the movement in the opposite direction can take place using the pyrotechnical belt tensioner. The roller 5.1.1 of the pair of rollers 5.1 preferably has a larger diameter, which is provided because of the larger contact surface for pyrotechnical tightening of the belt strap. A larger tightening path for tightening the belt strap lying flat against the passenger can thereby be covered so that the passenger participates relatively early in a total delay of the vehicle in the event of a collision.

Functions of a reversible active belt buckle, by means of which the belt buckle 1 can be moved between the feed position and the operating position, as well as functions of an in particular pyrotechnically triggered belt tensioner can be combined by the cable guide to tighten the belt strap in the event of a collision of the vehicle.

During movement from the feed position into the operating position, belt slack, in particular in the pelvic and upper body region of the passenger wearing the belt strap, is reduced.

The cable guide can thereby be formed in such a way that this requires a relatively small installation space.

Although the present invention has been described above by means of embodiments with reference to the enclosed drawings, it is understood that various changes and developments can be implemented without leaving the scope of the present invention, as it is defined in the enclosed claims.

1. A belt tensioner, comprising:
a cable guide at least partially surrounding a retaining cable of a vehicle seat belt,
wherein the vehicle seat belt includes a belt buckle tongue arranged movably on a belt strap and a belt buckle into which the belt buckle tongue is inserted, and
wherein the cable guide is arranged relative to the retaining cable so that movement of a portion of the cable guide extends a length of a guide path of the retaining cable and tightens the belt strap,
wherein the cable guide comprises
a first and second pair of guide rollers between which the retaining cable passes;
a pair of moveable rollers between which the retaining cable passes,
wherein the first pair of guide rollers is arranged on a first side of the pair of moveable rollers and the second pair of guide rollers is arranged on a second, opposite side of the pair of moveable rollers.

2. The belt tensioner of claim 1, wherein the pair of moveable guide rollers are part of a deflector which, for tightening the belt strap, deflects a region of the retaining cable from a straight guide path during movement from a starting position into an active position of the belt buckle.

3. The belt tensioner of claim 2, wherein the deflector is coupled to an electric motor configured to reverse the extension of the length of the guide path of the retaining cable.

4. The belt tensioner of claim 2, wherein the deflector is coupled to a pyrotechnical belt tensioner configured to extend the guide path of the retaining cable.

5. The belt tensioner of claim 2, wherein the deflector is coupled to a brake, wherein the brake is configured to fix the deflector in a deflected position.

6. The belt tensioner of claim 1, wherein the first and second pairs of guide rollers are fixed rollers, wherein the pair of moveable rollers are moveable between the first and second pairs of guide rollers.

7. A vehicle, comprising:
a vehicle structure;
a seat belt having belt buckle tongue arranged movably on a belt strap and a belt buckle into which the belt buckle tongue is inserted;
a retaining cable coupled to the vehicle structure and the belt buckle; and
a belt tensioner, which comprises a cable guide at least partially surrounding the retaining cable, wherein the cable guide is arranged relative to the retaining cable so that movement of a portion of the cable guide extends a length of a guide path of the retaining cable and tightens the belt strap,
wherein the cable guide comprises
a first and second pair of guide rollers between which the retaining cable passes;
a pair of moveable rollers between which the retaining cable passes,
wherein the first pair of guide rollers is arranged on a first side of the pair of moveable rollers and the second pair of guide rollers is arranged on a second, opposite side of the pair of moveable rollers.

8. The vehicle of claim 7, wherein the pair of moveable guide rollers are part of a deflector which, for tightening the belt strap, deflects a region of the retaining cable from a straight guide path during movement from a starting position into an active position of the belt buckle.

9. The vehicle of claim 8, wherein the deflector is coupled to an electric motor configured to reverse the extension of the length of the guide path of the retaining cable.

10. The vehicle of claim 8, wherein the deflector is coupled to a pyrotechnical belt tensioner configured to extend the guide path of the retaining cable.

11. The vehicle of claim 8, wherein the deflector is coupled to a brake, wherein the brake is configured to fix the deflector in a deflected position.

12. The vehicle of claim 7, wherein the first and second pairs of guide rollers are fixed rollers, wherein the pair of moveable rollers are moveable between the first and second pairs of guide rollers.

13. The belt tensioner of claim 1, wherein a first roller of the pair of moveable rollers is a different size than a second roller of the pair of moveable rollers.

14. The belt tensioner of claim 1, wherein the pair of moveable rollers move laterally between the first and second pairs of guide rollers.

15. The belt tensioner of claim 14, wherein the first and second pairs of guide rollers are in a fixed position and rollers of the pair of moveable rollers are coupled together so that the rollers of the pair of moveable rollers move laterally together.

16. The vehicle of claim 7, wherein a first roller of the pair of moveable rollers is a different size than a second roller of the pair of moveable rollers.

17. The vehicle of claim 7, wherein the pair of moveable rollers move laterally between the first and second pairs of guide rollers.

18. The vehicle of claim 17, wherein the first and second pairs of guide rollers are in a fixed position and rollers of the pair of moveable rollers are coupled together so that the rollers of the pair of moveable rollers move laterally together

19. (canceled)
